(19) United States
(12) Patent Application Publication
(10) Pub. No.: US 2009/0209287 A1
(43) Pub. Date: Aug. 20, 2009

(54) Cellular telephone with full computer

(76) Inventor: Moises Ravelo, Miami, FL (US)

Correspondence Address: Robert J. Van Der Wall, Grand Bay Plaza Suite 701, 2665 South Bayshore Drive, Coconut Grove, FL, 33133, US

(21) Appl. No.: 12/070,207

(22) Filed: Feb. 19, 2008

(51) Int. Cl. H04M 1/03

(52) U.S. Cl. 455/556.1; 455/557

(57) ABSTRACT

The present invention provides a handheld full function but miniaturized computer selectively mateable with a hands free capable cellular telephone that is insertable into a slot in the computer for both downloading data and charging the cell phone, all in a computer module the approximate lateral size and weight of a Blackberry® and with a user friendly capability. It includes a plethora of new features such as a business card scanner, LCD touch screen keyboard, GPS tracking, small CD drive, emergency alert, medical information (immediate diagnosis, treatment and medications), CD DVD player and video games, solar power panel, available control of the phone from the computer keyboard, and the like. It further provides the user with information storage using memory cards and A and B disc drives as well as a small CD drive C offering the capability to download data to office and/or home personal computers for safe keeping.

### BACKGROUND OF THE INVENTION

1. Field of the Invention

The present invention relates to the fields of wireless communication and digital computers. More specifically, the invention separably mates a cellular telephone having camera and video functions with a miniaturized “laptop” computer. The latter acts as a base into which the cell phone is inserted for downloading and charging and includes a liquid crystal display (LCD) touch screen with the full capabilities of a digital computer having a wireless connection to the internet. It also includes a business card scanner, small CD drive, and a plethora of functions found both in state of the art cellular telephones and laptop computers. Finally, the invention includes a large number of new and useful features, in both the cell phone and computer fields. In short, the invention is the new frontier for miniaturization of cellular telephone technology and handheld WiFi full function computers. It offers the ability to eliminate the weight and bulk of carrying around a laptop computer.

2. Description of the Prior Art

In the last several decades, the development of solid state electronics and miniature computer chips has led to ever increasing size and weight reduction of multi-function electronics devices. Cellular telephones have become progressively smaller at the same time as the number of functions they can perform has steadily and relentlessly increased. At the same time, laptop computers have become more powerful, having comparatively massive storage capacity, with ever increasing processing speed while becoming smaller and lighter. But so far as is known to the present inventor, no one has thus far compressed a full function computer to lateral dimensions about the size of Blackberry® especially with so many features.

A search of the prior art has shown only that cellular telephone technology has been combined with other functions, but not with a full function handheld computer. Examples are: Jenkins, et al., U.S. Pat. No. 7,065,381, Yach, et al., U.S. Pat. No. 7,295,836, and Kerner, et al., U.S. Pat. No. 7,146,191. Newman, et al., U.S. Pat. No. 6,757,551 purports to have combined a full function computer with a cell phone, but lacks both the miniaturization and the abundance of features found in the present invention.

### SUMMARY OF THE INVENTION

Bearing in mind the foregoing, it is a principal object of the present invention to provide a handheld full function computer in combination with a hands free capable cellular telephone that is insertable into a slot in the computer for both downloading data and charging the cell phone, all in a computer package the approximate lateral size and weight of a Blackberry® and with a user friendly capability.

A related object of the invention is to protect against the loss of valuable data resulting from accidental cell phone immersion in water by downloading the data to the full function computer when the cell phone is inserted into the computer slot, and thereafter transferring the data from the full function computer to an office or home PC.

Another principal object of the present invention is to combine the foregoing with a plethora of new features such as a business card scanner, LCD touch screen keyboard, GPS tracking, small CD drive, medical emergency alert, personal health and medications information (immediate diagnosis, treatment and medications), CD DVD player and video games, audio/video connections, solar power panel, available control of the phone from the computer keyboard, and the like.

An additional object of the invention is to combine the foregoing with an extensive amount of organizational capacity, information conveyance, accessibility to message keeping, storing and sharing techniques including pictures, appointment reminder with an alarm/reminder setting feature, and schedules.

A further object of the invention is to provide the user with an apparatus that offers efficiency and organization in obtaining and recording information that can later be easily accessed and used, and/or followed up through time sensitive and permanently conserving techniques.

Another object of the invention is to provide the user with information storage using memory cards and A and B disc drives as well as a small CD drive C offering the capability to download data to office and/or home personal computers for safe keeping.

An additional object of the invention is that it includes a business card port for reading and downloading and recording the entire text of a business card in the field as soon as it is received, which function is automatically activated by the card being slid into the port.

A related object of the invention is that the user can change the information recorded from a business card as needed.

Another related object of the invention is to establish the use of plastic business cards having a magnetic strip thereon. The magnetic strip is used for the following purposes: include in machine readable form all the data found on the user's business card with the user's picture, include all the data found on a new acquaintance's business card with his/her picture, time sensitive features such as appointments, luncheons, parties, birthdays, bar or bat mitzvahs, anniversaries, and personal data such as nicknames family member names, drink preferences and etc., and for sending automatic greetings on such special occasions, with the cards being reusable and changeable.

One more object of the invention is to combine all of the foregoing advantages in an apparatus that is aesthetically appealing by reason of a housing that includes a fashionable and trendy rubber and stainless steel combination that also provides a a nearly unbreakable structure.

Other objects and advantages will be apparent to those skilled in the art upon review of the following descriptions and upon reference to the appended drawings.

In accordance with a primary aspect of the invention there is provided a cellular telephone having camera and video functions with a miniaturized full function computer. The latter also acts as a base into which the cell phone is inserted for downloading data and charging and includes a liquid crystal display (LCD) touch screen with the full capabilities of a digital computer having a wireless connection to the internet. It also includes a business card scanner, small CD drive, and a plethora of functions found both in state of the art cellular telephones and laptop computers.

The invention includes a large number of new and useful features, in both the cell phone and computer fields. A sampling of these features are a business card scanner, LCD touch screen keyboard, GPS tracking, small CD drive, medical emergency alert, personal health and medications information (immediate diagnosis, treatment and medications), CD DVD player and video games, audio/video connections, solar power panel, picture retention, appointment reminder with an alarm setting feature, schedules, information storage using memory cards and A and B disc drives as well as a small CD drive C providing the capability to download data to office and/or home personal computers for safe keeping and from the separate cell phone that connects to the computer.

In accordance with a secondary aspect of the invention there is provided a business card port for reading and downloading and recording the entire text of a business card in the field as soon as it is received, which function is automatically activated by the card being slid into the port, the ability of the user to change the information recorded from a business card as needed, the use of plastic business cards having a magnetic strip thereon with the strip being used for including in machine readable form all the data found on the user's business card with the user's picture, including all the data found on a new acquaintance's business card with his/her picture, time sensitive features such as appointments, luncheons, parties, birthdays, bar or bat mitzvahs, anniversaries, and personal data such as nicknames family member names, drink preferences and etc., and for sending automatic greetings on such special occasions, with the cards being reusable and changeable.

In accordance with a further aspect of the invention there is provided an apparatus housing that is aesthetically appealing by reason of a fashionable and trendy rubber and stainless steel combination that also provides a nearly shockproof and unbreakable structure.

### BRIEF DESCRIPTION OF DRAWINGS

FIG. 1 is a front elevation perspective view of the computer module with the cell phone absent from the downloading and charging slot into which it is inserted.

FIG. 2 is a front elevation perspective view of the computer module as seen in FIG. 1, but with the grid showing on the LCD touch screen.

FIG. 3 is a front elevation perspective view of the computer module as seen in FIG. 2, but with the cell phone inserted into the downloading and charging slot.

FIG. 4 is a front elevation perspective view of the computer module shown supported in a belt carrier.

FIG. 5 is a rear elevation perspective view of the belt carrier only.

FIG. 6 is a rear planar perspective view showing the bottom and side of the computer module with CD DVD slot, business card slot and other connection sites.

FIG. 7 is a rear planar perspective view of the computer module showing the screen partially opened to reveal both the screen and the solar panel.

FIG. 8 is an enlarged view of the computer module LCD touch screen for describing the functions of all the keys.

FIG. 9 is an enlarged front perspective view of the two layer cell phone showing the phone layers closed, the primary keyboard, and the phone screen. The key functions are described.

FIG. 10 is a bottom perspective view of the two layer cell phone showing the phone layers open and the secondary keyboard.

FIG. 11 is an enlarged broken view of the bottom phone layer only and showing the secondary keyboard for describing the function of all the keys.

FIG. 12 is a top planar perspective view of a wireless keyboard accessory for the computer module.

FIG. 13 is a left rear side perspective view of a charging tray for supporting the computer module in a user accessible position.

FIG. 14 is a front perspective view of a vehicle cup holder insert for connection to the charging tray of FIG. 13.

FIG. 15 is a front perspective view of the charging tray of FIG. 13.

### DETAILED DESCRIPTION OF PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

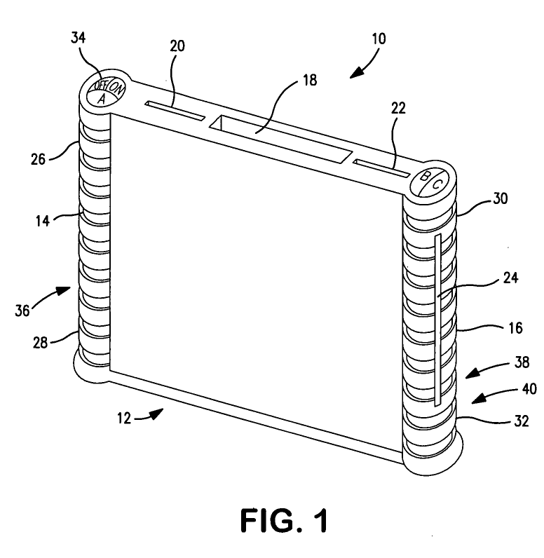

FIG. 1 is a front elevation perspective view of the computer module 10 with a LCD touch screen 12, rubber and stainless steel handgrips 14, 16, cell phone charging and downloading slot 18, memory card A slot 20, memory card B slot 22, business card slot 24, speaker screens 26, 28, 30, and 32, and power on/off button 34. Disposed inside of computer module 10 in proximity to hand grip 14 is hard drive A, 36, while hard drives B, 38, and C, 40, are similarly disposed in proximity to hand grip 16.

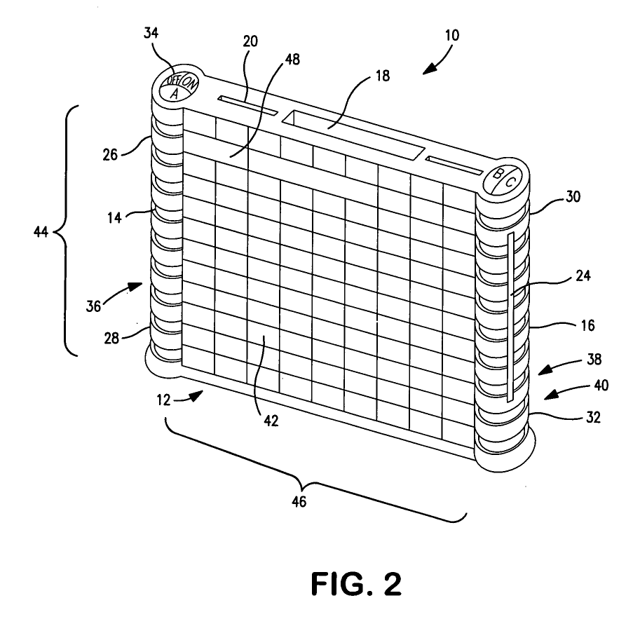

FIG. 2 is a front elevation perspective view of the computer module 10 as seen in FIG. 1, but with the key grid 42 showing on the LCD touch screen 12. Key grid 42 is comprised of a potential 120 rectangular multi-function key positions arranged in twelve ranks 44 and ten files 46. However, some positions may not be used as a key. The best example is that the second rank and first and second file positions are combined into a single “You have mail/messages” alert 48, and thus is not a key position at all.

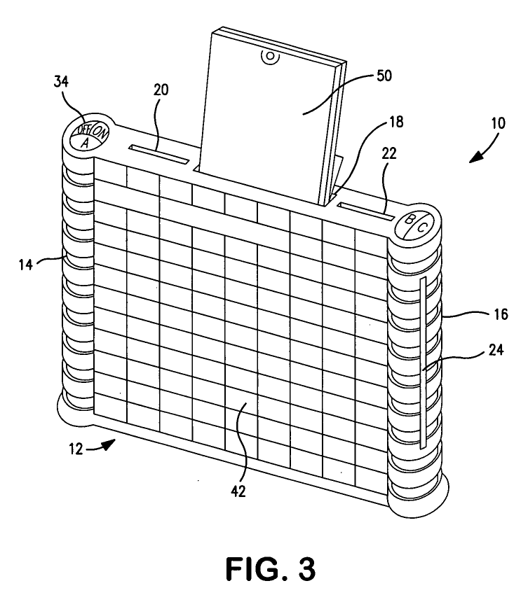

FIG. 3 is a front elevation perspective view of the computer module 10 as seen in FIG. 2, but with the cell phone 50 inserted into the cell phone downloading and charging slot 18.

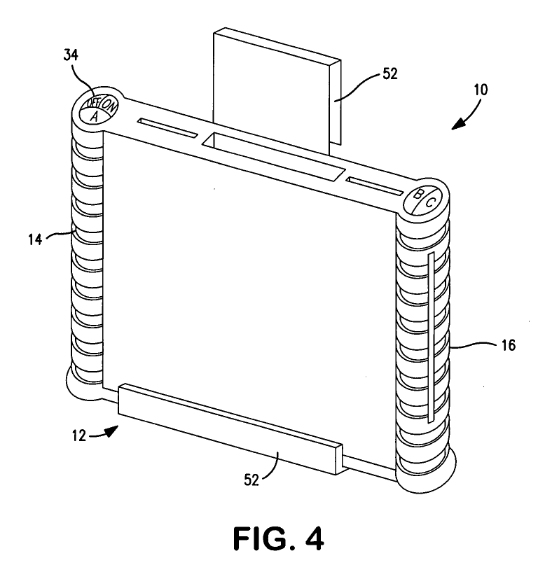

FIG. 4 is a front elevation perspective view of the computer module 10 shown in supported in a belt carrier 52.

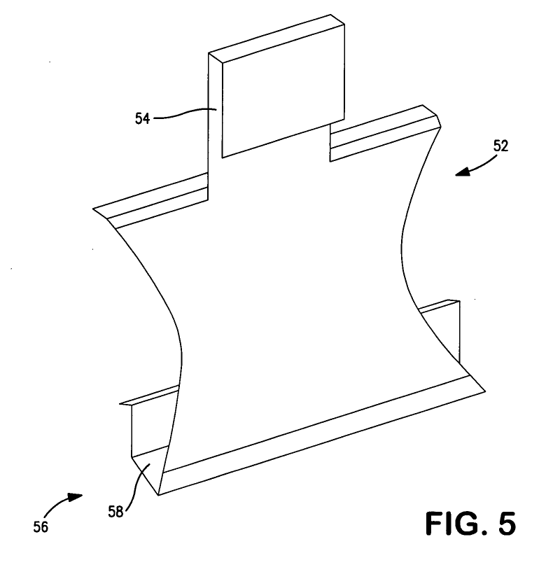

FIG. 5 is a rear elevation perspective view of the belt carrier 52 only. It is comprised of a belt straddling backwardly facing channel 54, forwardly facing computer straddling channel 56 and web 58.

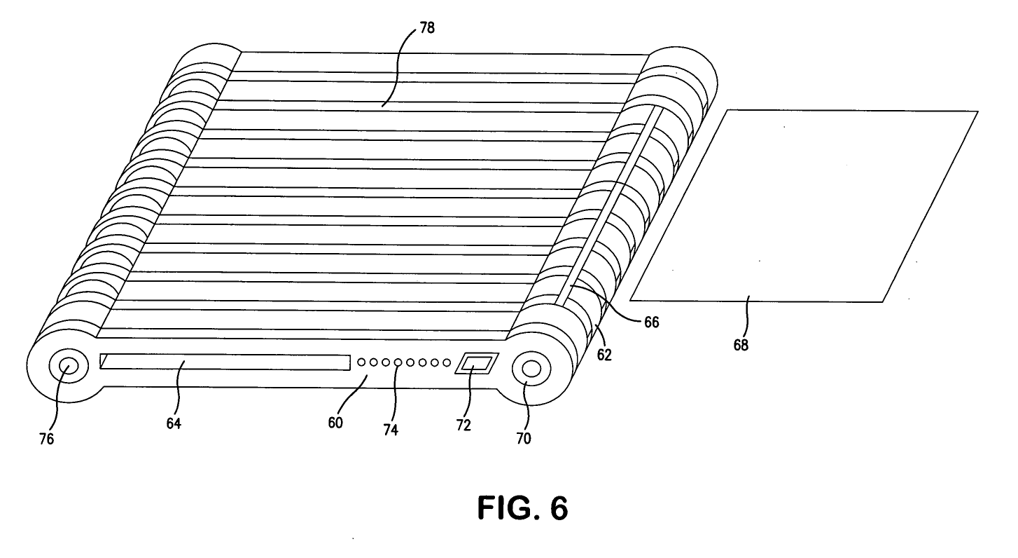

FIG. 6 is a rear planar perspective view showing the computer module bottom 60 and computer module side 62 with CD DVD slot 64, which is also used for video games, and business card slot 66 in proximity to business card 68. Also seen are CD DVD video player on/off open screen button 70, disc eject button 72, audio/visual connection ports 74, charging jack receptacle 76, and rubber and stainless steel housing back lid 78.

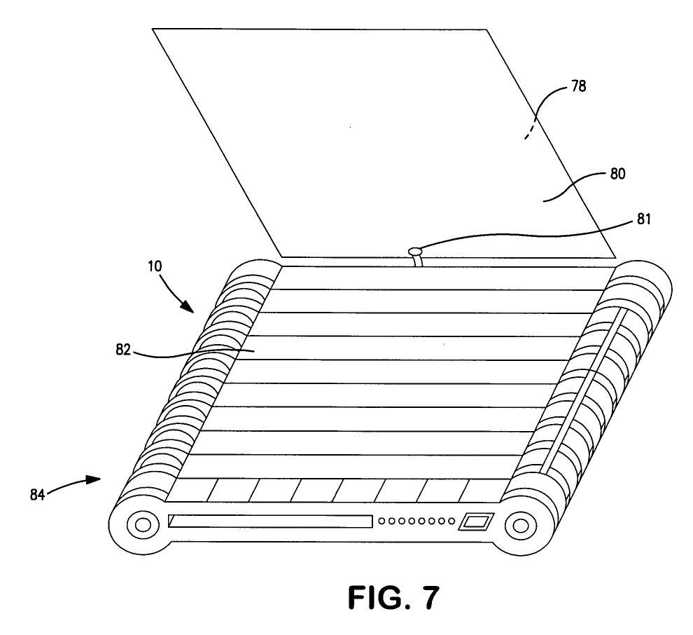

FIG. 7 is a rear planar perspective view showing the housing back lid 78 on the opposite side of which is disposed LCD viewing screen 80. The housing back lid 78 and LCD viewing screen 80 are supported by pivot point 81 so that the screen 80 can be turned around to cooperate with LCD touch screen 12. The housing back lid 78 and LCD viewing screen 80 are shown only partially opened to reveal both the screen 80 and the solar photovoltaic panel 82. The solar photovoltaic panel 82 is used to charge batteries, or operate a CD DVD player 84 disposed inside the computer module 10 adjacent the CD DVD slot 64.

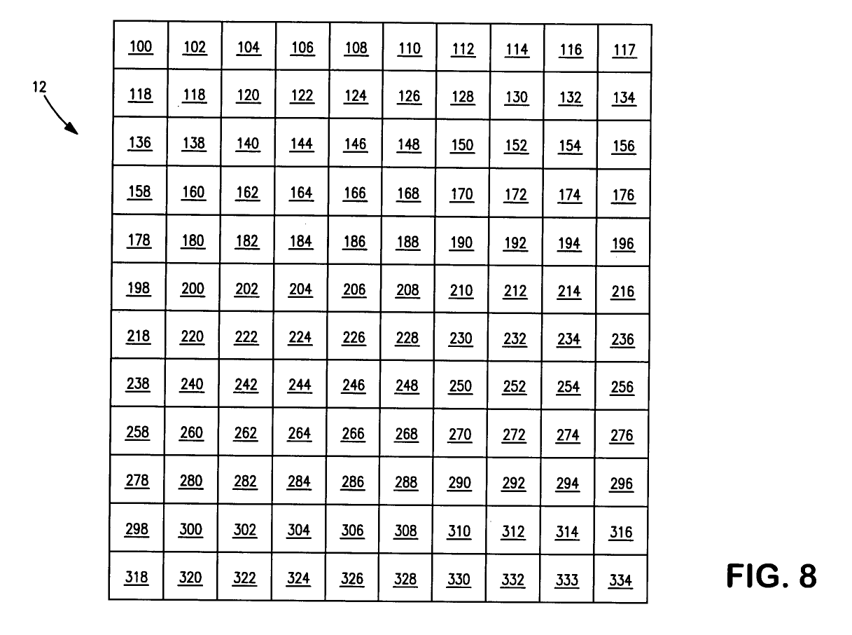

FIG. 8 is an enlarged view of the LCD touch screen 12 for describing the functions of all the keys, many of which are multi-function. The computer module 10 has multiple user identifying features which are activated through a menu triggered by the identification key 100. These features include voice recognition, finger print recognition technology, and other more usual identifying techniques such as passwords involving numbers and/or text codes that enable accessibility. Since the invention is comprised of at least two modules, i.e., the computer module and the cell phone, it is necessary for the user to select which modules are to be employed at any given moment in time. The switch key 102 downloads information in the form of a menu from which the user is able to select both the computer and the phone, the phone only, or the computer only. Since the invention is capable, as is any full function computer, of multi-tasking, the computer is programmed for screen on screen (picture in picture) viewing. This function is activated by the screen on screen key 104. The tools key 106 controls such features as fonts, volume, ring tones, battery check, error check, margins, size of letters and colors, bold, italics, underline letters, copy and paste, margins, center, color of letters, and etc. The computer of course includes a word processor in the nature of MS Word®, but with different and more efficient writing features. This feature is activated by word processor key 108.

Because the invention is a combination of a full function computer and a telephone, a database of contacts is vital. The contacts key 110 triggers access to an extraordinarily broad database that includes people the user knows professionally, personally, casual acquaintances and such data as name of business, pictures, personal names or nicknames, addresses, telephone numbers, birthdays, anniversaries, pictures, e-mail addresses, invitations extended, means of making the acquaintanceship with the contact, reason for importance of the contact, relationship with other contacts, etc. A related feature is the appointment book activated by the appointment key 112. The appointment book contains all of the user's appointments scheduled listed chronologically with the precise day and time of each appointment. The user can then connect directly to the contact database and schedule with calendar and memorandum features to write the purpose of the meeting and goal(s) to be achieved. The calendar includes automatic recognition of scheduled vacation days, national bank and school holidays, information from the contact database such as contact's anniversary and birthdays, etc. The appointment book function also sets an alarm or reminder of appointment 24 hours before it is scheduled, and then again one hour before appointment and then 30 minutes and finally 5 minutes before it is to begin. It also accommodates to do lists and includes a voice recognition option which means the user can fill in with the voice option. Access to the computer' pictures, videos, photo album, etc. for use as screen savers is achieved using the screen saver key 114. The computer module find, on and off and restart functions are activated using the system control key 116. Internet access to Google, e-mail and all the rest of the Internet is obtained through the use of the Internet Explorer key 118. The receipt of e-mail, text messages, video mail, e-faxes and voice mail is signalled by the “You have mail” key 118, which is programmed to light up and/or ring, and which provides a short cut to the message center of the computer module.

There are five keys associated with caller ID functions, caller ID key 120, dial key 122, ignore call key 124, add number to directory key 126, and end call key 128. Related thereto is forward contact key 130 which is used to send contact just received to a destination determined by the user, such as the system contacts database or the address book. Another related function is the last call key 132, which allows the user to listen to either message the first missed call first, or the last call missed first. Saving information such as messages can be activated using the menu brought up by use of the save to memory key 134. The menu allows selection of the memory location from among memory drives A, B or C, or removable memory disks of A or B, or in the main drive disk C which is located in the bottom of the computer module 10.

News, weather and financial key 136 is a shortcut to news web sites such as Fox News, CNN, MSNBC and networks as well as to weather, financial news on stocks and sports. Do not disturb key 138 provides a menu of alternative automated messages that the user can select to then be sent to the user's annoying and imprudent callers. The menu provides the following options: At the moment I cannot attend to your call but I will see to it that it is returned. Please do not call again. I appreciate your concern but you need not bother again. Thank you but I am not interested. Sorry but I am indisposed. Please refrain from calling me again. You are in violation of my right to privacy—please do not call again. Also, an automated message explaining you cannot attend the call and the amount of time for a return call can be selected. The mute light only key 140 provides the user with the option to communicate with someone else through light only, that is the third party will receive word from the user by the user simply pressing the mute light only key 140.

In the center of the LCD touch screen 12 is a square that imitates the number and letter keypad of a touch tone telephone. The first of these is the number 1 key 144. The second is the number 2 key 146, alternately used for the letters A, B, and C. The next is the number 3 key 148, alternately used for the letters D, E, and F. To the right of key 148 is the music key 150, which accesses memory that stores and download the user's favorite songs and other music. Yellow and white pages key 152 brings up a menu for access to internet sites so the user can locate appropriate listings. To activate features in the nature of smart home and vehicle such a home HVAC thermostat, lights, appliances, entertainment or vehicle start, engine warmup, unlocking the vehicle, air conditioning or heating the vehicle, etc., the smart home/vehicle key 154 is used to bring up the appropriate menu.

One of the most advanced features of the present invention is accessed through the card scanner/maker key 156. This is a multipurpose feature that in the first instance scans business cards to input their content into the appropriate contacts directory. But it can also be used for the following purposes: send via the internet an automated greeting, such as “it was nice meeting you today, let's meet soon to discuss the matter that we were discussing at length, or, let's schedule lunch, I sincerely hope that we can do business together in the future,” etc. The menu of this feature also allows the user to access the appointment book to set up a follow up meeting. Insertion of a later business card will result in automatic correction of an address or phone number in the contacts database.

The text direct key 158 provides the user with the ability to text message a caller about how long it is estimated to take before the caller's call is returned. This is a noiseless and automated message to go to an incoming caller that gives the caller peace of mind that you are aware he/she is trying to reach you, however, you can attend to their issue at the following choices of minutes: 10, 20, 30, 40, 50, or 60. Or, at the user's option this feature will automatically (voice or text) ask the incoming caller to Text you with his or her specific concern because your cell phone is forcibly silent and unusable at the location that you are in. The ring tones key 160 provides access to all the tones that a user may desire, or choose to record or obtain from an outside source. The call return key 162 activates a list of all calls received up to a programmable number, a scroll down cursor, and a dial initiator which brings up the dial tone before dialing the desired number.

At this point, the second row of the number and letter keypad of a touch tone telephone is encountered. The first key is the number 4 key 164, alternately used for the letter G, H, and I. The second is the number 5 key 166, alternately used for the letters J, K, and L. The next is the number 6 key 168, alternately used for the letters M, N, and O. To the right of the 6 key 168 is the real estate key 170. It activates a menu of services concerning the marketplace, buying and selling, listings both direct and comparison, sales records, internet links to public records, etc. Next is the E-Bay key 172 for a shortcut to the internet site for buying or selling almost anything. Following that is the do it yourself key 174. It contains a menu of items concerning building houses, home improvement projects like laying tile, plumbing repairs, electrical wiring, home additions like garages, gardening, sprinklers, etc, and also offers a shortcut to internet sources for similar related information. After that is the bank direct key 176, which shortcuts to banking web sites to avoid credit card fraud and third party banking. The auto mass text key 178 facilitates texting simultaneously everyone or a significant plurality of contacts in the user's address book and/or contacts database for such things as advertising, a special event, an invitation, etc. The redial key 180 has two related functions. The first is the conventional redialing of the last dialed outgoing call. The second is to activate #69 to determine whose phone number was used to call the user. For any missed calls, there is the normal missed calls key 182.

At this point, we return again to the number and letter keypad of a touch tone telephone, now up to the third row. The first key is the number 7 key 184, alternately used for the letters P, Q, R, and S. The second is the number 8 key 186, alternately used for the letters T, U, and V. The next is the number 9 key 188, alternately used for the letters W, X, Y, and Z. To the right of the number 9 key 188 is the accounting key 190 for the user's personal and business accounting records, including receipts, profits and losses, taxes, etc.

Another of the innovative features of the present invention is the medical, health and medications key 192. This key provides access by the user to a wealth of medical knowledge to assist in diagnosis of symptoms and immediate treatment including medication appropriate to the diagnosis. While this feature is not to be considered a substitute for a competent and licensed medical care provider, it does provide the user and his/her friends with a way to know what the symptoms could mean before the patient meets with the medical care provider, useful information to convey to the care provider, the ability to be able to corroborate a care provider's diagnosis, treatment and prescribed medications as a means of checks and balances for asking pertinent questions and challenging the medical care professionals to prevent or minimize misdiagnosis or misprescribing. The encyclopedia key 194 is to obtain scientific and historical facts that have not been distorted by Wikipedia type opinions. The courier key 196 brings up a menu of choices for mail courier services. Selection of one of the options results in rapid notification to such choices as FedEx, UPS, DHL, or USPS for pick up service. The 911 key 198 initiates an immediate and automatic video recording of everything going on without stopping which is automatically sent to the nearest 911 facility. It also alerts a preselected contact or relative where the user is, using the GPS module and that there is an emergency. Finally, the 911 facility is sent the GPS data for use by the police. The silent alarm key 200 brings up a menu of the local police department, poison control unit, fire rescue department, child welfare services, or other pertinent government hotlines to whom the user may not be able to speak, to summon appropriate assistance. The call record key 202 keeps a user adjustable number of each of incoming, outgoing, and missed calls. The numbers only key 204 limits the touch tone telephone keypad to numbers selections and turning off that function. The “Oh” key 206 is used for dialing the operator and the 411 information center. The star (*) key 208 limits the touch tone telephone keypad to letters and turning off that function. The portfolio key 210 monitors the user's investments, 401K, pension, retirement fund, Bonds, Stocks, CD's, IRA's, money markets, trust accounts, and/or regular accounts. The system translator key 212 provides conversions between metric and English units, roman and arabic numerals, comparisons between cyrillic, arabic, hebrew, western and other alphabets, and morse code. This key also includes a shortcut to internet language translators. The voice command key 214 activates a digital voice recorder to allow dictation of a vocal diary or journal of everyday events, appointments, meeting notes, etc.

The global positioning system (GPS) key 216 provides all the benefits of the GPS system in locating addresses, identifying user location, and locating the invention if it is lost or stolen. The medical emergency key 218 operates much like a medical emergency bracelet in providing medical care providers and other people with user allergies, chronic ailments or conditions, medications being taken by user, medical history, identification of the user, user's home address, next of kin locator information to obtain medical care consents when the user cannot given consent, identification of user's normal medical care providers, preferred medical care facilities in the event of an emergency, organ donor information and living will instructions. The hold call key 220, conference call key 222, clear all key 224, speaker phone key 226, and end call key 228 are all self explanatory.

The travel key 230 activates a menu with internet travel web sites such as Travelocity, Orbitz, Expedia, Priceline, etc. These sites connect the user directly with travel information to give the best rates in travel and where people go at any time of the year, as well as ticketing and booking capabilities. Provides time zones for all parts of the world, weather, currency exchange and a brief profile. The virtual tour key 232 can advertise all that the user owns on user's web site. This feature provides the user with the ability of being able to make a virtual tour of anything the user owns and that way the user is able to market it perfectly on the internet and/or anywhere else it can be sold.

The Q or ! symbol is the 238 key. The W or @ symbol is the 240 key. The E or * Symbol is the 242 key. The R or # symbol is the 244 key. The T or $ symbol is the 246 key. The Y or % symbol is the 248 key. The U or ̂ symbol is the 250 key. The I or down symbol is the 252 key. The O or & symbol is the 254 key. The P or (symbol is the 256 key. The “caps lock” is the 258 key. The A or > symbol is the 260 key. The S or <symbol is the 262 key. The D or \ symbol is the 264 key. The F or / symbol is the 266 key. The G or ? symbol is the 268 key. The H or = symbol is the 270 key. The J or + symbol is the 272 key. The K or − symbol is the 274 key. The L or ) symbol is the 276 key. The “Shift” is the 278 key. The “Tab” is the 280 key. The Z or . symbol is the 282 key. The X or , symbol is the 284 key. The C or ″ symbol is the 286 key. The V or ′ symbol is the 288 key. The B or : symbol is the 290 key. The N or ñ symbol is the 292 key. The M or ; symbol is the 294 key. The “spell check” is the 296 key. The “Control” is the 298 key. The “Options” is the 300 key. The “ESC” is the 302 key. The back space is the 304 key. The space bar is the 306 key. The forward space is the 308 key. “Dictionary” is the 310 key. “Thesaurus” is the 312 key. “World Atlas and Astronomy” (BC, AD, present) is the 314 key. “Files” (view, edit, save, copy, paste, and etc.) is the 316 key. “Print Document” is the 318 key. “Edit” is the 320 key. “Delete” is the 322. The “Battery Life” is the 324 key. “Memory Space Left” is the 326 key. “Connect to Different System” (PC, Laptop, Companion Cell Phone, Other Combination Cell Phone Computer) is the 328 key. “Help” (for the present invention) is the 330 key. “Calculators” (all types standard, scientific calculator, business calculator, chemistry definitions and code meanings and etc.) is the 332 key. “Enter” is the 334 key.

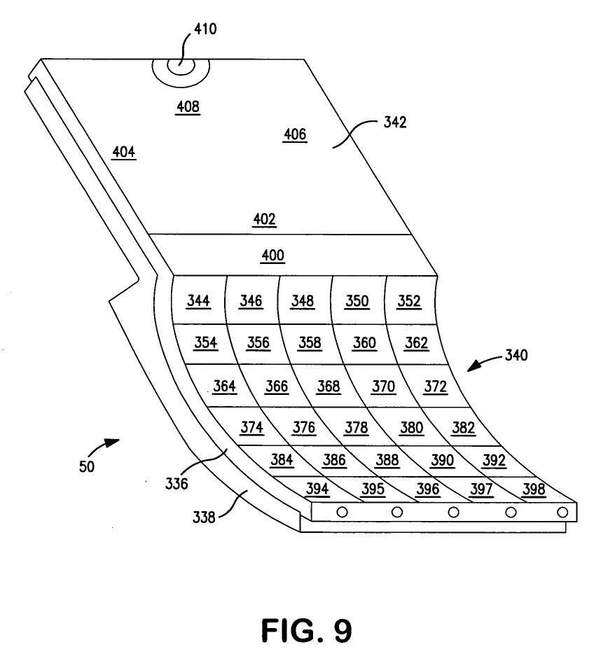

FIG. 9 is an enlarged front perspective view of the two layer cell phone 50 showing the top phone layer 336 and bottom phone layer 338 closed together, the primary keyboard 340, and the phone screen 342. On/off/pin key 344 brings up a menu for turning the phone on or off and the computer on or off. If the phone is programmed to require a user pin number, the user employs the on/off/pin key 344 in combination with the shift key 384 to enter a pin number to verify the user is authorized to operate the invention. Download key 346 will trigger a download of all new information into the computer module 10 when cell phone 50 is inserted into download slot 18. Photo/video key 348 brings up on phone screen 342 a menu for control of the camera/video cam, the photo shoot/album, and screen saver functions. Text message key 350 brings up a menu to select text message send, sent, and received. Diary key 352 brings up a menu to access the appointments book, calendar, schedule, and contacts information. Missed calls key 354 brings up a menu to obtain last call in, all missed calls which can be sorted by date, time, who called, first one last, or last one first. As with the touch screen 12 of the computer module 10, the primary keyboard 340 of cell phone 50 includes a square that imitates the number and letter keypad of a touch tone telephone. The first of these is the number 1 key 356 which with the shift key 384 brings up a menu for voice mail, e-mail, picture mail, and video mail. The second is the number 2 key 358, alternately used with the shift key 384 for the letters A, B, and C. The next is the number 3 key 360, alternately used for the letters D, E, and F. To the right of key 360 is the GPS key 362. Next is dialed calls key 364, which brings up a menu to access all dialed calls sorted by date, time, who called, first one last, or last one first. At this point, the second row of the number and letter keypad of a touch tone telephone is encountered. The first key is the number 4 key 366, alternately used for the letter G, H, and I. The second is the number 5 key 368, alternately used for the letters J, K, and L. The next is the number 6 key 370, alternately used for the letters M, N, and O. To the right of the 6 key 370 is the tools key 372, which brings up a menu to control tools, features and ringtones. Next is incoming calls key 374 which brings up a menu to access all received incoming calls sorted by date, time, who called, first one last, or last one first. At this point, we return again to the number and letter keypad of a touch tone telephone, now up to the third row. The first key is the number 7 key 376, alternately used for the letters P, Q, R, and S. The second is the number 8 key 378, alternately used for the letters T, U, and V. The next is the number 9 key 380, alternately used for the letters W, X, Y, and Z. To the right of the number 9 key 380 is the redial key 382, which with the shift key 384 accesses a scroll contacts function. Next is the shift/shift lock key 384 which is double keyed for turning shift lock on and off. The star (*) key 386 when used with the shift key 384 brings up a menu for clearing last or clearing all. The 0 or “Oh” key 388 is the operator key, which in combination with the shift key 384 accesses a menu for control of 911 calls, which in turn triggers a black box type voice recorder, and allows for the sending medical or other alerts to third parties. The # key 390 in combination with the shift key 384 accesses a menu for the calculators. The hold/conference key 392 controls the hold, conference call and connect call functions.

The following keys are for using the cell phone as a remote control for DVD, TV, music, and video games use. The play or (shift) fire key is 394. The stop or (shift) jump/kick key is 395. The pause or (shift) punch/stab key is 396. The rewind or (shift) walk/run backwards key 397. The fast forward or walk/run forward key is 398. Turning now to the phone screen 342, there are several touch screen functions. The caller ID function is located at 400. The view mail function is at 402, which brings up a menu for voice mail, text messages, e-mail, and video message. The dial start function is at 404. The end call function is at 406. The accept incoming call function is at 408. The camera/video/web cam lens is seen at 410.

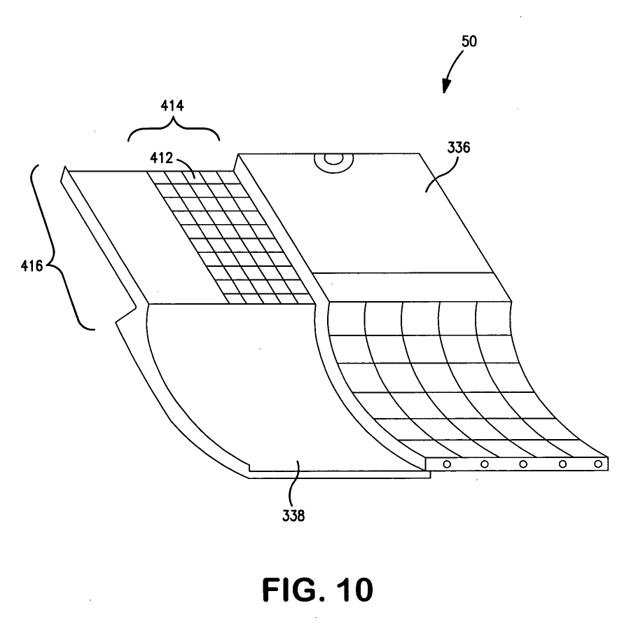

FIG. 10 is a top perspective view of the two layer cell phone 50 showing the top phone layer 336 and bottom phone layer 338 open and the secondary keyboard 412 comprised of 5 ranks 414 and 10 files 416.

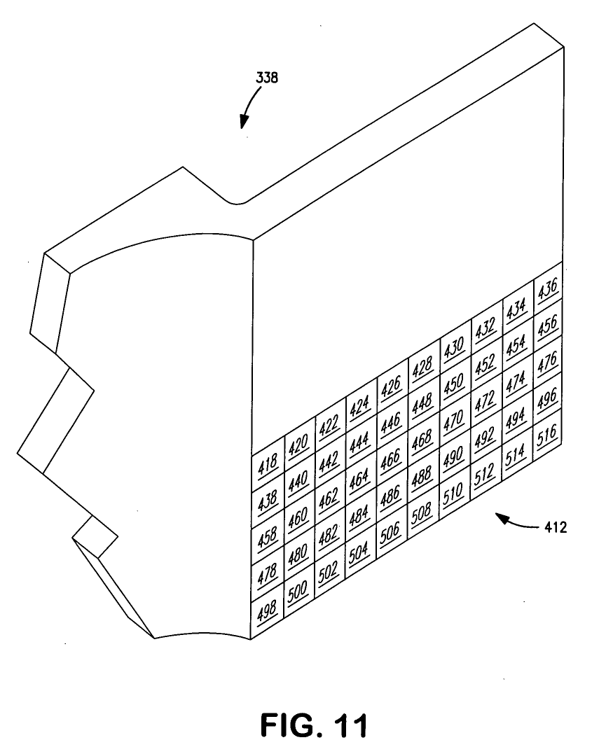

FIG. 11 is an enlarged broken view of the bottom phone layer 338 and showing secondary keyboard 412 for describing the function of all the keys. The secondary keyboard 412 is similar to a typewriter or computer keyboard. In the first rank are number 1 key 418, number 2 key 420, number 3 key 422, number 4 key 424, number 5 key 426, number 6 key 428, number 7 key 430, number 8 key 432, number 9 key 434, and zero key 436. In the second rank arranged in the usual order are letter keys: q or (shift) Q key 438, w or (shift) W key 440, e or (shift) E key 442, r or (shift) R key 444, t or (shift) T key 446, y or (shift) Y key 448, u or (shift) U key 450, i or (shift) I key 452, o or (shift) O key 454, and p or (shift) P key 456. In the third rank there is first the shift/shift lock key 458, then the letter keys: a or (shift) A key 460, s or (shift) S key 462, d or (shift) D key 464, f or (shift) F key 466, g or (shift) G key 468, h or (shift) H key 470, j or (shift) J key 472, k or (shift) K key 474, and l or (shift) L key 476. The fourth rank begins with automated message key 478, tab key 480 followed by letter keys as follows: z or (shift) Z key 482, x or (shift) X key 484, c or (shift) C key 486, v or (shift) V key 488, b or (shift) B key 490, n or (shift) N key 492, m or (shift) M key 494, and , or (shift) . key 496. The fifth and final rank begins with on/off key 498. Then follows space bar key 500, % or (shift) & key 502, + or (shift) − key 504, ′ or (shift) ″ key 506, @ or (shift) # key 508, / or (shift) \ key 510, ? or (shift) = key 512, enter or (shift) e-mail key 514, and back space or (shift) spell check/grammar key 516.

Above the secondary keyboard 412 is typing screen 518 and next to both of them is viewing screen 520 for viewing photographs, videos, etc.

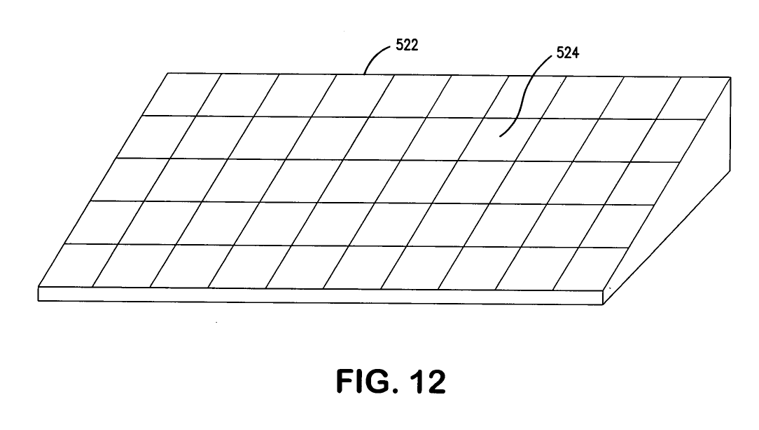

*FIG. 12 is a top planar perspective view of a wireless keyboard accessory 522 for the computer module 10. The keys 524 will be the same as those described for the secondary keyboard 412 of the cell phone 50 and thus will not be repeated here.

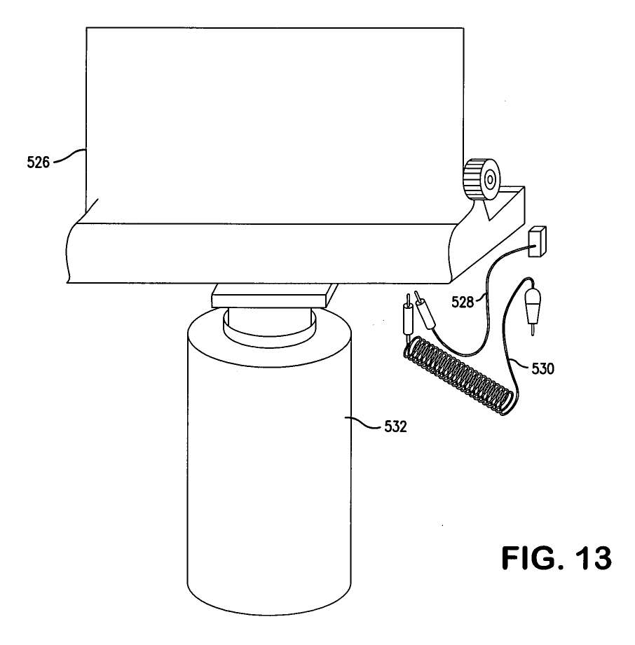

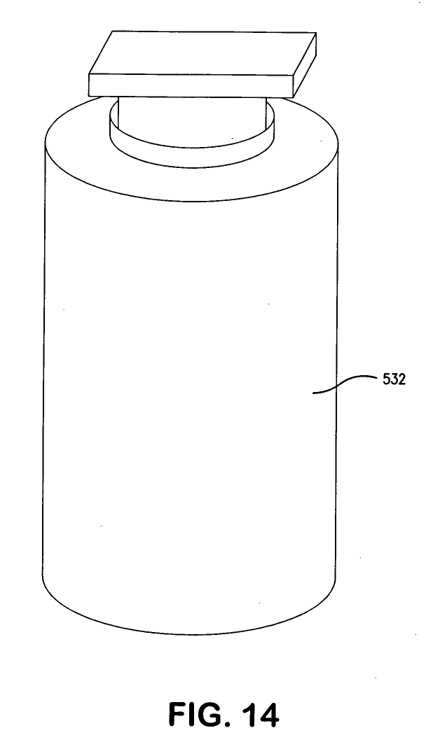

*FIG. 13 is a left, rear side perspective view of a charging tray 526 for supporting the computer module 10 in a user accessible position. It comes with power cords 528 and 530, the first for connection to a convention AC wall socket, and the second for plugging into a vehicle DC cigarette lighter socket. It is shown in proximity to the vehicle cup holder insert 532 of FIG. 14.

*FIG. 14 is a front perspective view of a vehicle cup holder insert 532 for connection to the charging tray 526 of FIG. 13.

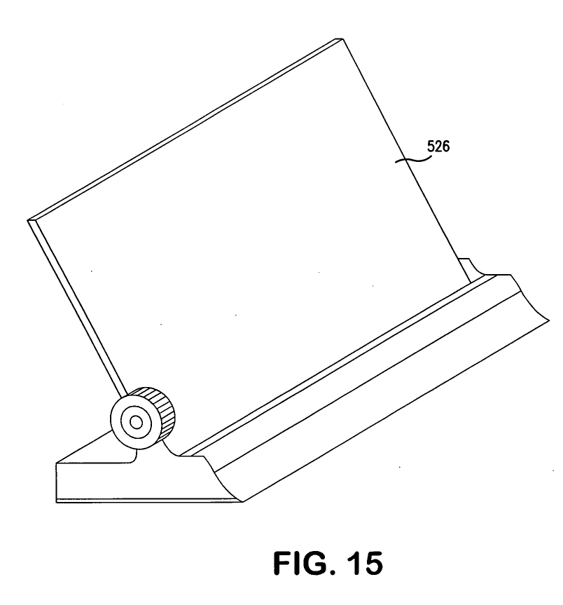

FIG. 15 is a front, left side perspective view of the charging tray 526 of FIG. 13.

While the invention has been described, disclosed, illustrated and shown in various terms or certain embodiments or modifications which it has assumed in practice, the scope of the invention is not intended to be, nor should it be deemed to be, limited thereby Such other modifications or embodiments as may be suggested by the teachings herein are particularly reserved, especially as they fall within the breadth and scope of the claims here appended.

What is claimed is:

1. A combination cellular telephone and full function computer comprising:
a cellular telephone having a capability to be selectively inserted into a slot of a portable full function computer to download new information in the phone and to charge the phone;
the computer having internet access, with both the computer and phone being fully operable both when mated together or when separate, the computer having key functions to control operation of the phone when mated together; and
the computer being miniaturized to handheld size and weight, having a business card scanner, and a liquid crystal display (LCD) touch screen.

2. The combination cellular telephone and full function computer of claim 1 wherein both the phone and computer further include Global Positioning System (GPS) tracking capability.

3. The combination cellular telephone and full function computer of claim 2 wherein the computer further includes a 911 key which triggers at least one of the following actions (a) immediate and automatic video and audio recording by the phone if in the download slot of everything going, (b) calling 911 with a prerecorded message to send the GPS location of distress and advising of the recording if applicable and (c) automatically alerting a preselected contact of distress and the GPS location thereof.

4. The combination cellular telephone and full function computer of claim 1 wherein both the phone and computer further include contacts, calendar, appointment book, schedule, and alarm.

5. The combination cellular telephone and full function computer of claim 4 wherein the computer further includes a card scanner key activating a multipurpose feature with a menu that in a first instance scans business cards through a slot in the computer to input their content into a computer based contacts directory, and in a second instance sends via the internet an automated greeting, such as at least one of “it was nice meeting you today, let's meet soon to discuss at length what we began discussing,” “let's schedule lunch,” and “I sincerely hope that we can do business together in the future,” and in a third instance allows access the appointment book to set up a follow up meeting.

6. The combination cellular telephone and full function computer of claim 5 wherein the computer further includes a feature in which insertion of a later modified business card will result in automatic correction of an address or phone number in a computer database of contacts.

7. The combination cellular telephone and full function computer of claim 6 wherein the computer further includes a text direct key with a menu to select one of (a) to automatically text message a caller using information in the contacts database about how long it is estimated to take before that call is returned, and includes a capability to select choices of minutes as follows: 10, 20, 30, 40, 50, 60 and 120 and (b) automatically by one of voice and text ask a caller to advise a specific concern because the phone is unusable when the call is made.

8. The combination cellular telephone and full function computer of claim 6 wherein the computer further includes a mass text key that facilitates texting simultaneously a plurality of contacts in the contacts database for such things as advertising, a special event, and an invitation.

9. The combination cellular telephone and full function computer of claim 1 wherein the computer further comprises a solar power panel and CD DVD video games player.

10. The combination cellular telephone and full function computer of claim 1 wherein the telephone further comprises a two layer construction selectively openable to reveal a secondary keyboard having substantially the function keys of a computer keyboard, and a screen.

11. The combination cellular telephone and full function computer of claim 1 wherein the computer further includes an identification key triggering at least one of voice recognition technology, finger print recognition technology, and other more usual identifying techniques such as passwords involving numbers and text codes that enable accessibility.

12. The combination cellular telephone and full function computer of claim 1 wherein the computer further includes a smart home/vehicle key used to bring up an appropriate menu to activate via the internet including smart home and vehicle features such as at least one of a home HVAC thermostat, lights, appliances, entertainment, vehicle start, engine warmup, unlocking a vehicle, vehicle air conditioning, and vehicle heating.

13. The combination cellular telephone and full function computer of claim 1 wherein the computer further includes a real estate key that activates a menu of services concerning marketplace conditions, buying and selling, listings both direct and comparison, sales records, and internet links to public records.

14. The combination cellular telephone and full function computer of claim 1 wherein the computer further includes a do it yourself key that triggers a menu of items concerning building houses, home improvement projects like laying tile, plumbing repairs, electrical wiring, home additions like garages, gardening, sprinklers, and also offers a shortcut to internet sources for similar related information.

15. The combination cellular telephone and full function computer of claim 1 wherein the computer further includes a medical key which brings up a menu of medical knowledge to assist in diagnosis of symptoms and immediate treatment including medication appropriate to the diagnosis concerning what certain symptoms could mean before meeting with a medical care provider, useful information to convey to the care provider, offering an ability to be able to corroborate a care provider's diagnosis, treatment and prescribed medications, as a means of checks and balances for asking pertinent questions and challenging medical care professionals to minimize misdiagnosis or misprescribing, and offers internet access to such web sites as Web MD®.

15. The combination cellular telephone and full function computer of claim 1 wherein the computer further includes an encyclopedia key to obtain scientific and historical facts that are accurate.

16. The combination cellular telephone and full function computer of claim 1 wherein the computer further includes a courier key that brings up a menu of choices for mail courier services wherein selection of one of the options results in rapid notification via the internet to such choices as FedEx®, UPS®, DHL®, or USPS for pick up service.

17. The combination cellular telephone and full function computer of claim 1 wherein the phone includes communication means and keys for use of the phone as a remote control for DVD, TV, music, and video games use.
